(19) United States
(12) Patent Application Publication
(10) Pub. No.: US 2016/0102493 A1
(43) Pub. Date: Apr. 14, 2016

(54) WIND TURBINE AND WIND TURBINE TOWER

(71) Applicant: WOBBEN PROPERTIES GMBH, Aurich (DE)

(72) Inventors: Frank Pollmann, Aurich (DE); Roy Kersten, Hohenwarte (DE); Stefan Medoch, Magdeburg (DE)

(21) Appl. No.: 14/888,073

(22) PCT Filed: Apr. 10, 2014
(86) PCT No.: PCT/EP2014/057303

§ 371 Date: Oct. 29, 2015

(30) Foreign Application Priority Data
Apr. 30, 2013 (DE) 10 2013 207 908.7

(51) Int. Cl. E06B 5/11; E06B 3/70; E06B 1/60

(52) U.S. Cl. CPC E06B 5/113; F03D 11/04; E06B 1/6046; E06B 3/70; E06B 2003/7051

(57) ABSTRACT

A wind turbine comprising a tower with an access door is provided. The access door has a door lock and, on its outer side, a baffle plate which extends substantially over the entire surface of the door and has a recess. A doorknob is provided in the region of the recess. An outer side of the baffle plate at least partially projects outwards beyond the door lock.

### BACKGROUND

1. Technical Field

The present invention relates to a wind turbine and to a wind turbine tower.

2. Description of the Related Art

Wind turbines typically have a tower and an access door in the lower region of the tower. The door serves to enable service and maintenance staff to enter the wind turbine whereas non-authorized individuals are intended to be kept from entry.

It is therefore important that the access door is configured in such a manner that non-authorized individuals cannot gain entry to the wind turbine. In recent times, thieves have acquired entry to wind turbines in order to steal metal.

In the German patent application establishing priority, the following documents were searched by the German Patent and TradeMark Office: DE 28 37 805 A1; DE 10 2007 016 756 A1; AT 006 967 U1; FR 2 588 606 A1; GB 2 185 056 A and EP 1 873 337 A2.

### BRIEF SUMMARY

One or more embodiments of the present invention are directed to a wind turbine and a wind turbine tower with an improved access door.

In at least one embodiment a wind turbine comprising a tower with an access door is provided. The access door has a door lock and, on its outer side, a baffle plate which extends substantially over the entire surface of the door and has a recess. A doorknob is provided in the region of the recess. An outer side of the baffle plate at least partially projects outwards beyond the door lock.

According to one aspect of the present invention, the access door has, on its inner side, a grid consisting of vertical and horizontal struts.

According to a further aspect of the present invention, a distance between adjacent horizontal struts or between adjacent vertical struts is ≦60 cm and, in particular, ≦30 cm.

According to a further aspect of the present invention, a perforated plate is provided between the grid structure and the baffle plate.

According to a further aspect of the present invention, the access door is fastened to a tower wall via clamping plates.

One or more embodiments relates to a wind turbine tower comprising an access door, wherein the access door has a door lock and, on its outer side, a baffle plate which extends substantially over the entire surface of the door and has a recess. A doorknob is provided in the region of the recess. An outer side of the baffle plate at least partially projects outwards beyond the door lock.

According to one or more embodiments, the access door complies at least with DIN EN ISO 1627: 2011-09 and its burglar resistance is level 4.

One or more embodiments of the invention relates to a concept of providing an access door for a wind turbine tower which has greater security against burglary. For this purpose, a baffle plate can be provided on the outer side of the door. The baffle plate has a recess in the region of the lock and of the doorknob. The doorframe can be fastened to the tower wall by means of clamping plates. Horizontal and vertical cross-struts which together form a grid structure are provided on the inner side of the door. The distance between adjacent struts is preferably ≦60 cm.

The doorframes can optionally be provided on the outside. Doorframes of this type are composed of a hardened material.

Further refinements of the invention are the subject matter of the dependent claims.

### BRIEF DESCRIPTION OF THE SEVERAL VIEWS OF THE DRAWINGS

Advantages and exemplary embodiments of the invention are explained in more detail below with reference to the drawing.

FIG. 1 shows a schematic illustration of a wind turbine according to the invention,

FIG. 2 shows a schematic illustration of an outer side of an access door according to a first exemplary embodiment,

FIG. 3 shows a schematic illustration of an inner side of an access door according to the first exemplary embodiment, and

FIG. 4 shows a sectional view along the section A-A from FIG. 2.

### DETAILED DESCRIPTION

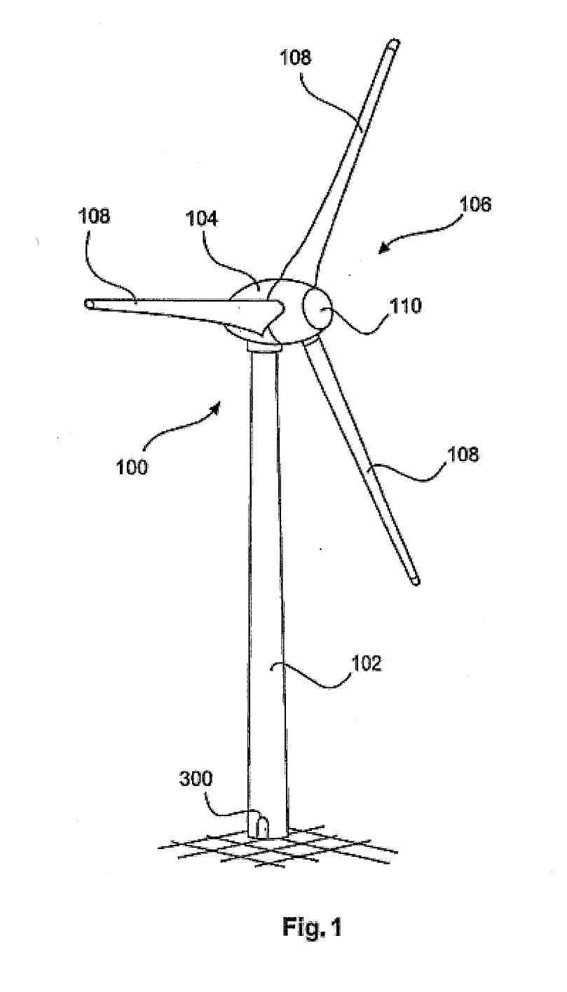

FIG. 1 shows a schematic illustration of a wind turbine according to the invention. The wind turbine 100 has a tower 102 and a nacelle 104. A rotor 106 with three rotor blades 108 and a spinner 110 is provided on the nacelle 104. When in operation, the rotor 106 is set into a rotational movement by the wind. A generator is connected directly or indirectly to the rotor, and therefore a rotational movement of the rotor leads to a rotational movement of the electric generator which then generates electrical power. The pitch or the angle of incidence of the rotor blades 108 can be changed by pitch motors on the rotor blade roots of the respective rotor blades. An access door 300 is provided in the lower region of the tower 102 of the wind turbine. Said access door 300 is equipped with improved protection against burglary.

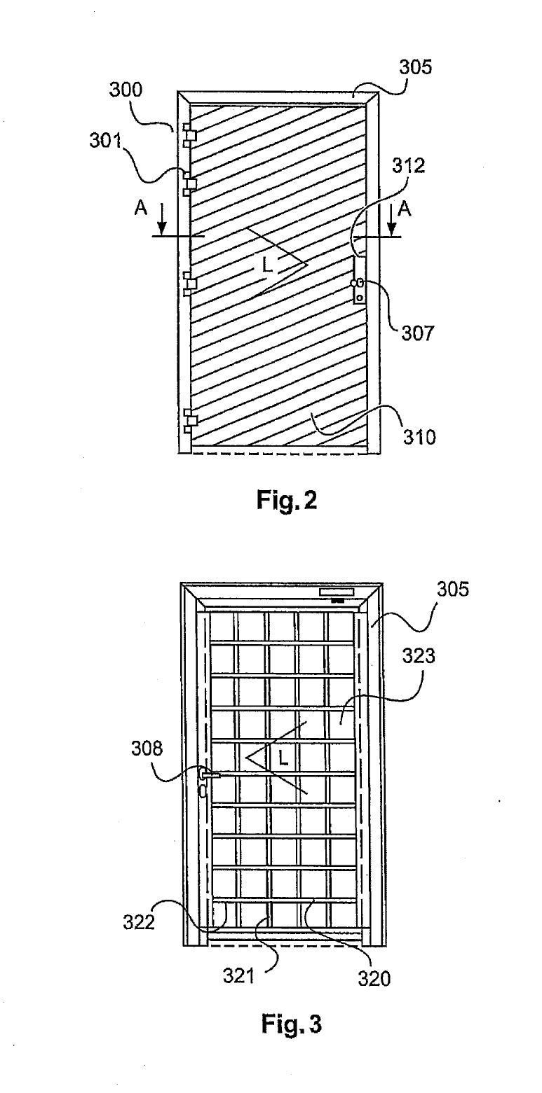

FIG. 2 shows a schematic view of an outer side of an access door for a wind turbine according to a first exemplary embodiment. The access door 300 has a frame 305 and/or hinges 301 by means of which the door can be opened. A baffle plate 310 is provided on the outer side of the door. The baffle plate 310 has a recess 312 in the region of the doorknob 307. The effect which can therefore be achieved is that the region of the doorknob 307 and of the door lock is set back in relation to the baffle plate 310. A burglar can therefore be prevented from being able effectively to use, for example, a crowbar or the like.

FIG. 3 shows a schematic illustration of an inner side of an access door of a wind turbine according to the first exemplary embodiment. The access door has a frame 305 and vertical and horizontal struts 321, 322. The vertical and horizontal struts 321, 322 form a grid structure 320. The distance between adjacent horizontal and/or vertical struts is ≦60 cm and, in particular, ≦30 cm. A perforated plate 323 can optionally be provided behind the grid structure 320, i.e., between the grid structure 320 and the baffle plate 310. The door has a door handle 308 on the inner side.

The grid structure 320 on the inner side of the access door 300 makes it possible to ensure that, even if the baffle plate 310 has been removed, access into the wind turbine can be effectively prevented.

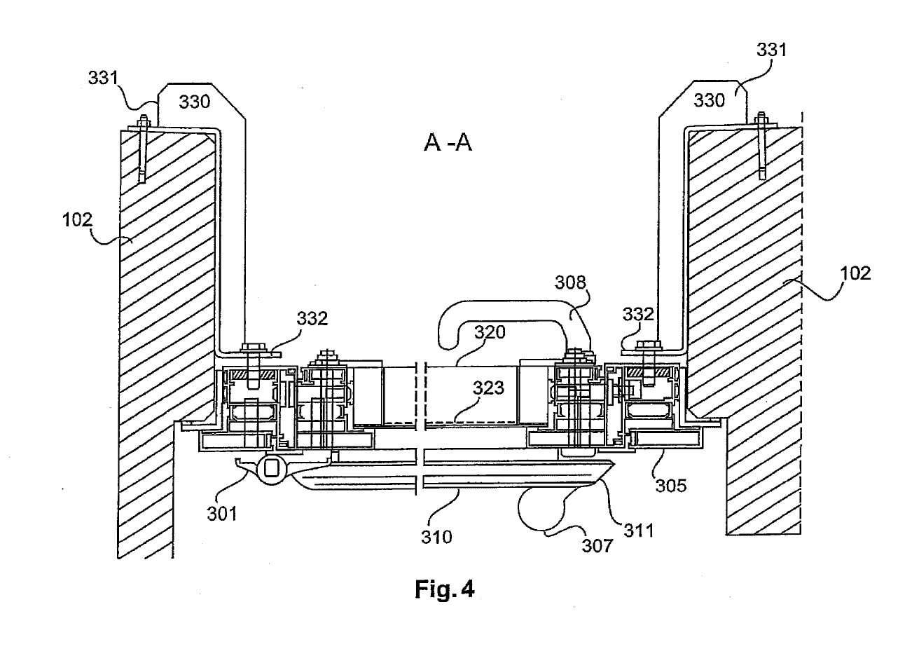

FIG. 4 shows a sectional view along the section A-A of FIG. 2. The access door 300 is fastened to the wall 102 of the tower by means of clamping plates 330. The clamping plates 330 have a first end 331, which is fastened to the wall 102 of the tower, for example by means of screws, and a second end 332 which is fastened to a frame 305 of the door, for example, by means of screws. The door has, on its outer side, a baffle plate 310 which has a bevelled configuration at its ends 311. A grid structure 320 consisting of vertical and horizontal struts 321, 322 is provided on the inner side of the door. The struts can be, for example, welded to one another.

A door handle 308 can be provided on the inner side and a doorknob 307 can be provided on the outer side. The baffle plate 310 preferably at least partially projects beyond the doorknob 307. The doorknob 307 and a lock can be provided in the region of a recess 312 of the baffle plate 310.

The door 300 can be fastened to a doorframe 305 by means of door hinges 301.

The baffle plate 310 can be screwed down from the inside.

Holes can optionally be provided in the door or above the doorframe in order to provide passive ventilation of the interior of the tower.

The distance between adjacent vertical or horizontal struts 321, 322 is preferably ≦30 cm.

Loosely mounted round material can optionally be provided in the vertical and/or horizontal struts 321, 322 which can prevent the grid bars from being sawn through.

The perforated grid 323 serves as an obstruction to burglary.

1. A wind turbine, comprising:
a tower including an access door having an inner side and an outer side, the access door including:
a door lock;
a baffle plate that extends substantially over the entire outer surface of the door and has a recess, wherein an outer side of the baffle plate at least partially projects outwards beyond the door lock; and
a doorknob provided in a region of the recess.

2. The wind turbine according to claim 1, wherein the access door has, on the inner side, a grid that includes vertical and horizontal struts.

3. The wind turbine according to claim 2, wherein a distance between adjacent horizontal struts or between adjacent vertical struts is 60 cm or less.

4. The wind turbine according to claim 1, wherein the access door further includes perforated plate between the grid structure and the baffle plate.

5. The wind turbine according to claim 1, wherein the access door is fastened to a tower wall of the wind turbine by clamping plates.

6. A wind turbine tower, comprising;
an access door, including:
a door lock;
a baffle plate on an outer side of the access door, the baffle plate extending substantially over the entire surface of the door and having a recess, wherein an outer side of the baffle plate at least partially projects outwards beyond the door lock; and
a doorknob at the recess.

7. The wind turbine tower according to claim 6, wherein the access door has, on the inner side, a grid that includes vertical and horizontal struts.

8. The wind turbine tower according to claim 7, wherein a distance between adjacent horizontal struts or between adjacent vertical struts 60 cm or less.

9. The wind turbine tower according to claim 6, wherein the access door further includes a perforated plate between the grid structure and the baffle plate.

10. The wind turbine according to claim 3, wherein the distance between adjacent horizontal struts or between adjacent vertical struts is 30 cm or less.
